(19) United States
(12) Patent Application Publication
(10) Pub. No.: US 2014/0182854 A1
(43) Pub. Date: Jul. 3, 2014

(54) FLUID LOSS CONTROL PILL WITH INTERNAL BREAKER AND METHOD

(71) Applicant: SUPERIOR ENERGY SERVICES L.L.C., Harvey, LA (US)

(72) Inventor: Sumitra Mukhopadhyay, The Woodlands, TX (US)

(73) Assignee: Superior Energy Services, L.L.C., Harvey, LA (US)

(21) Appl. No.: 13/833,089

(22) Filed: Mar. 15, 2013

Related U.S. Application Data
(63) Continuation-in-part of application No. 13/729,122, filed on Dec. 28, 2012.

(51) Int. Cl. C09K 8/92; E21B 33/13

(52) U.S. Cl. CPC C09K 8/92; E21B 33/13
USPC 166/305.1; 507/209; 507/219

(57) ABSTRACT

A method of treating a subterranean formation. The method may include providing a fluid loss control pill that comprises an aqueous base fluid, a gelling agent, and an internal breaker that is selected from the group consisting of inorganic delayed acids or inorganic salts. The method can include introducing the fluid loss control pill into a subterranean formation, allowing the internal breaker to reduce the viscosity of the pill after a delay period, and allowing the fluid loss control pill to break.

### CROSS-REFERENCE TO RELATED APPLICATION

This application is a continuation-in-part of U.S. patent application Ser. No. 13/729,122, filed on Dec. 28, 2012, which is incorporated herein by reference.

### BACKGROUND OF THE INVENTION

The present disclosure relates to methods and compositions for treating subterranean formations, and more specifically to internal breakers for fluid loss control pills. The fluid loss control pills of the present disclosure comprise an aqueous base fluid, a gelling agent, and an internal breaker. Alternatively, the fluid loss control pills comprise encapsulated particles each having a polymer coating encapsulating an internal breaker in a base fluid.

Fluid loss control pills consisting of highly viscous polymers are used during well simulations and completions to stop seepage or steady brine loss to the formation. Fluid loss occurs when the hydrostatic pressure head on the fluid is greater than the formation pressure. One of the reasons fluid loss control is necessary is to prevent losses of expensive high density brines. Fluid loss can also disrupt the well pressure control because of high gas influx into the wellbore and can cause an unsafe condition. Furthermore, uncontrolled brine infiltration to the formation can create a chemical imbalance, which may lead to formation damage. The most common method of fluid loss control is to pump a viscous pill into the thief zone. Clean-up of these pills is necessary after the completion work as these can be quite damaging to the formation and difficult to be removed from the perforation tunnel. Both internal and external breakers for the pills are used. However, the internal breakers, generally oxidizers, are rapid in action and cannot provide controlled breaking over time. A strong acid, namely 10 to 15% hydrochloric acid, is employed as the most common external breaker in the prior art. This strong acid can cause a corrosive and unsafe environment.

### SUMMARY OF THE INVENTION

A method of treating a subterranean formation is disclosed. In one embodiment, the method includes providing a fluid loss control pill that comprises an aqueous base fluid, a gelling agent, and an internal breaker that is selected from the group consisting of inorganic delayed acids and inorganic salts. The method further includes introducing the fluid loss control pill into a subterranean formation, allowing the internal breaker to reduce the viscosity of the pill after a delay period, and allowing the fluid loss control pill to break. In one embodiment, the inorganic salts include alkali metal salts selected from a group consisting of bisulfite and bisulfate ions. In another embodiment, the inorganic delay acids are selected from the group consisting of sulfamic acid, sulfonic acid and its derivatives, toluensulfonic acid, phosphonic acid and its derivatives, and aluminum chloride and other Lewis acids. The inorganic salts and inorganic delayed acids may be encapsulated.

As per the teachings of the present disclosure, in one embodiment the gelling agent comprises at least one polymer selected from the group consisting of a natural polymer, a synthetic polymer, xanthan, a xanthan derivative, a guar, a guar derivative, cellulose, and a cellulose derivative. The gelling agent may comprise a crosslinked gelling agent that crosslinks the gelling agent in a crosslinking reaction. The crosslinked gelling agent may include at least one crosslinking agent comprising a polyvalent metal ion, such as aluminum, antimony, boron, chromium, zirconium or titanium (including organotitanates).

Additionally, the fluid loss control pill may comprise an additive selected from the group consisting of propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent.

In another embodiment, a method of treating a subterranean formation is disclosed that comprises providing a fluid loss control pill that comprises an aqueous base fluid, a gelling agent, and an internal breaker that comprises inorganic salts that includes alkali metal salts. The fluid loss control pill is introduced into a subterranean formation, and the internal breaker is allowed to generate an acid after a delay period, which in turn allows the fluid loss control pill to break. In one embodiment, the alkali metal salts are selected from a group consisting of bisulfite and bisulfate ions. More specially, the alkali metal salts are selected from a group consisting of bisulfate, bisulfite, metabisulfate, metabisulfite salts, ammonium chloride (NH₄Cl), ammonium oxalate ((NH₄)₂C₂O₄H₂O), sodium bicarbonate (NaHCO₃), sodium hydrosulfide (NaHS), sodium bisulfate (NaHSO₄), monosodium phosphate (NaH₂PO₄), disodium phosphate (Na₂HPO₄), and also the potassium salts. Generally, the breaker generates the acid from between 2 hours to 7 days. The gelling agent may comprise at least one polymer selected from the group consisting of a natural polymer, a synthetic polymer, xanthan, a xanthan derivative, a guar, a guar derivative, cellulose, and a cellulose derivative. In this embodiment, the fluid loss control pill may comprise an additive selected from the group including propylene glycol, a gel stabilizer, a clay fixer, a bridging particulate, a surfactant, a corrosion inhibitor, a biocide, a pH control additive, an oxidizer, an enzyme, an encapsulated breaker, an inorganic acid, an organic acid, and a weighting agent. The breaker may be a solid form, a solution form, or a slurry form, or may be encapsulated.

In one embodiment, the subterranean formation temperature is between 100 degrees F. and 400 degrees F. Generally, the fluid loss control pill has a pH between 4 to 11. In one preferred embodiment, the step of introducing the fluid loss control pill for a well treatment may be for a fracturing treatment, a gravel packing treatment or a loss circulation treatment.

### BRIEF DESCRIPTION OF THE DRAWINGS

FIG. 1 is a schematic of a rig with a well extending therefrom.

FIG. 2 is a chart showing the experimental results of a fluid loss control pill comprising encapsulated particles each having a polymer coating encapsulating an internal breaker.

### DETAILED DESCRIPTION OF THE PREFERRED EMBODIMENTS

As noted earlier, the fluid loss control pill comprises a viscous fluid that will be gelled. Aqueous base fluids that are commonly used in oilfield operations usually include sodium chloride brines, potassium chloride brines, calcium chloride brines, calcium bromide brines, zinc chloride brines, and zinc bromide brine.

Suitable gelling agents that may or may not be crosslinked, depending on the pH of the pill, or the pH of the environment in which the pill will be used, include but are not limited to: xanthan, xanthan derivatives, guar, guar derivatives (such as hydroxypropyl guar, carboxymethyl guar, and carboxymethylhydroxyprpyl guar), cellulose and cellulose derivatives (such as hydroxyethyl cellulose (HEC), and carboxymethylethyl cellulose), succinoglycan, carboxymethyl HEC, double-derivatized' HEC (DDHEC), and polyols. In some embodiments, the gelling agent may be crosslinked; in others, the gelling agents may not be crosslinked. Preferably, the gelling agent is crosslinked before the pill is placed in the subterranean formation (e.g. before pumping or during pumping). The crosslinked gelling agent may include at least one crosslinking agent comprising a polyvalent metal ion. For instance, the crosslinking agent may contain a metal ion such as aluminum, antimony, boron, chromium, zirconium or titanium (including organotitanates).

The fluid loss control pill may be broken (i.e. its viscosity may be reduced) by lowering the pH of the fluid by addition of an internal breaker of the present invention. The internal breakers comprise solid or liquid inorganic acids, or inorganic salts, which will generate an acid down hole in a delayed fashion that will break the fluid loss control pills. The delay period may vary from a few hours to several days.

Examples of suitable inorganic acids include sulfamic acid (H₃NSO₃), sulfonic acid and its derivatives, such as trifluoromethanesulfonic acid (also known as triflic acid (CF₃SO₃H)) and toluenesulfonic acid (C₆H₄CH₃SO₃H), phosphonic acids and its derivatives (ROP(OH₂) where R is an organic radical such as C₆H₅, as in phenylphosphonic acid), aluminum chloride (AlCl₃), or other Lewis acids. Other examples of inorganic acids that can be used as breakers include hydrochloric acid, nitric acid, sulfuric acid, phosphoric acid, boric acid, and hydrofluoric acid. These inorganic acids can be encapsulated or emulsified to delay their activity.

Examples of suitable inorganic salts for use in the delayed acid breakers of the present disclosure have a structure described by the formula: NaHSO₃ or Na₂S₂O₅. The internal breakers may comprise slow acid forming inorganic salts in water. The examples include but are not limited to alkali metal salts containing bisulfite and bisulfate ions. More specifically, examples of suitable inorganic salts include, but are not limited to bisulfate, bisulfite, metabisulfite, and metabisulfate salts.

A feature of one embodiment of this disclosure is that the internal breakers are environmentally friendly and they can provide a controlled break from a few hours to over several days.

Generally speaking, the amount of the breaker to include is an amount sufficient to neutralize any inhibitor that may have been placed in the fluid loss control pill and reduce the pH of the fluid loss control pill to a level sufficient to break it. This amount will be determinable by one of ordinary skill in the art with the benefit of this disclosure. In some embodiments, this may be from about 5 lb./1000 gal. to about 30 lb./1000 gal. based on the volume of the fluid loss control pill.

The inorganic salts and inorganic acids used in the internal acid breakers of the present invention can have any suitable form. For instance, these compositions can be used in a solution form, an encapsulated form, a solid form, liquid form, solution, slurry or an emulsion form. For the solution form, suitable exemplary solvents include propylene glycol, propylene glycolmonomethyl ether, dipropyline glycol monomethyl ether, and ethylene glycol monobutyl ether. When in solid form, the materials may be crystalline or granular in nature. The solid forms may be encapsulated or provided with a coating to delay their release into the fluid. Encapsulating materials and methods of encapsulating are well known in the art.

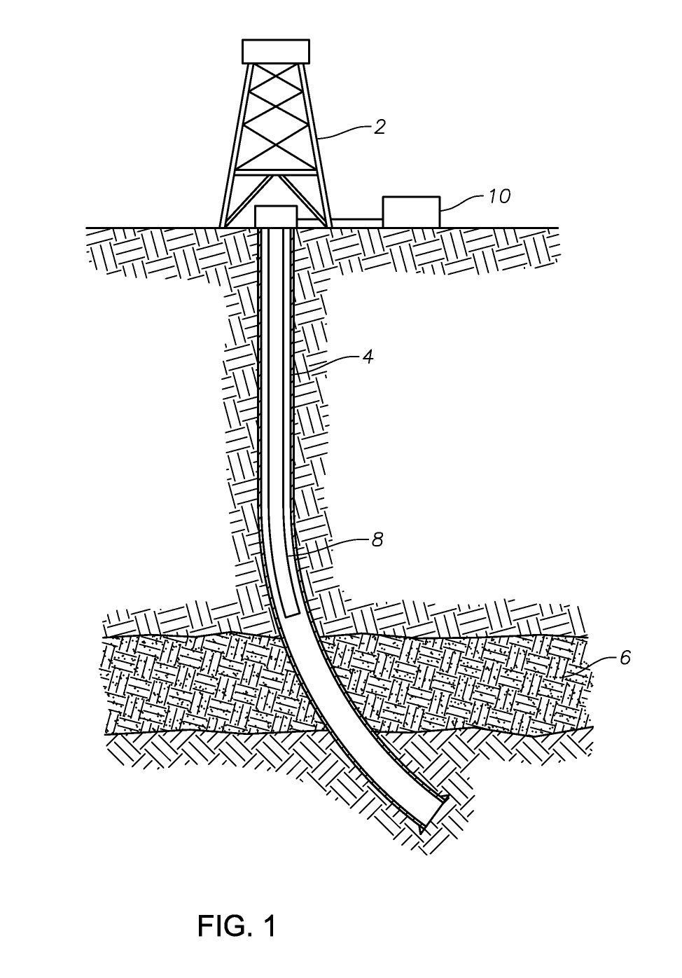

Referring now to FIG. 1, a schematic of a representative rig 2 with a well 4 extending therefrom is illustrated. In the FIG. 1, the well contains a casing string 4 intersecting a subterranean reservoir 6, which will now be described. The casing string 4 may contain perforations for communicating the reservoir 6 with the internal portion of the casing string 4 for communication of hydrocarbons to the surface as is readily understood by those of ordinary skill in the art. FIG. 1 depicts a concentrically placed string 8, wherein the string may be a production string, a work string (such as drill pipe), or a coiled tubing string. The internal breakers can be used in drilling, fracturing, gravel packing and other applications where a fluid loss control pill is used. As understood by those of ordinary skill in the art, the rig 2 will contain pump and mixing means 10. Hence, the pill herein disclosed can be mixed at the surface and pumped into the well 8 to a desired location for the treatment disclosed herein.

The following are possible additives that may be added to the solution containing the internal breaker: time delay inhibitors, oxidizers, enzymes, organic acids, inorganic acids, corrosion inhibitors and emulsifiers. See U.S. Pat. No. 7,347,265, assigned to BJ Services Company, columns three through seven, which is incorporated herein by reference. As understood by those of ordinary skill in the art, different well conditions (e.g. temperature, pressure, corrosive environment, etc.) dictate the specific types of additives that will be used.

The internal acid breakers of the present invention are generally stable at a pH of about 8 or above. To maintain the delay, preferably the pH should be maintained at 8 or above. To maintain this pH, the internal acid breakers or the pill may comprise an inhibitor. The inhibitor may further delay the generation of the acid from the inorganic salt compositions, and may also neutralize the generated acid during the delay period. Suitable inhibitors include bases and/or buffers. Examples of some preferred inhibitors may include sodium hydroxide, potassium hydroxide, magnesium oxide, or potassium carbonate buffer

Adding the internal acid breaker by way of an emulsion may be useful. Simultaneous addition of the internal acid of the present disclosure and a crosslinking agent is one embodiment of use because it allows the breaker to be distributed evenly within the base gel. Sometimes, it may be difficult to mix the breaker into an already crosslinked pill. In one preferred embodiment, the pill is generally delivered by ‘diluting’ it with brine so that pumping friction pressure is not too high. Hence, the internal breaker can be mixed with this brine solution with gentle shear so that mixing and dispersion may not be an issue.

In the emulsion embodiments, (e.g. where the fluid loss control pill base gel has a low pH), the emulsion of the internal acid breaker may be formed with water, a suitable emulsifying surfactant, optionally an inhibitor (e.g. wherein it is desirable to protect the inorganic salts from degradation during addition to a low pH base gel or when a longer delay time is desired), and optionally a crosslinking agent. Another advantage of placing the breaker in an emulsion is that the breaker is mixed in the pill in a relatively even fashion.

Suitable emulsifying surfactants for use in emulsification embodiments of this invention include any surfactant which is capable of making an oil in water emulsion, and which does not adversely affect a component of the pill or the breaker. Suitable emulsifying surfactants for use in the emulsification embodiments of this disclosure include any surfactant which is capable of making an oil in water emulsion, and which does not adversely affect a component of the pill or the breaker.

Alternatively, the fluid loss control pill comprises encapsulated particles each having a coating encapsulating an internal breaker in a base fluid. The fluid loss control pill may be in the form of a solution, a slurry, or a solid. The base fluid for the fluid loss control pill in a solution form or the slurry form may be any brine. Examples of suitable base fluids include, but are not limited to, sodium chloride brine, potassium chloride brine, calcium chloride brine, calcium bromide brine, zinc chloride brine, zinc bromide brine, and sodium formate brine.

The coating may be formed of a polymer. The polymer may be insoluble in water at the temperature in the wellbore, while the internal breaker may be soluble in water. For purposes of this description, soluble refers to solubility values greater than 1 mg per 100 mL of water, and insoluble refers to solubility values less than 1 mg per 100 mL of water.

In one embodiment, the polymer coating may be insoluble in water at the temperature in the wellbore, but soluble in water at a higher temperature. In another embodiment, the polymer coating may be insoluble in divalent brines, but soluble in monovalent brines. The polymer coating may be a highly viscous polymer. The polymer coating may be formed of a crosslinked polymer. Examples of suitable crosslinked polymers include, but are not limited to, alginate and chitosan. The polymer coating may be formed of a porous material such that the internal breaker may diffuse through the polymer coating. For example, the polymer coating may be formed of polyvinylidene chloride (PVDC). Alternatively, the polymer coating may be self-degradable such that the internal breaker is released as the polymer coating degrades. For example, the polymer coating may be formed of polyvinylidene chloride (PVDC). In another alternative, the polymer coating may be formed of a material that is crushed under higher pressure such that the internal breaker may be released as the hydrostatic head above the fluid loss control pill in the wellbore crushes the polymer coating (i.e., the internal breaker is released from the polymer coating through a crush-release mechanism). For example, the polymer coating may be formed of a material that begins to be crushed at pressures above about 4,000 psi. An example of a suitable polymer coating material may be, but is not limited to, polyvinylidene chloride (PVDC).

The coating of the encapsulated particle may be formed of any material capable of encapsulating an internal breaker and providing the encapsulated particles with the ability to control fluid loss in a wellbore. Examples of suitable coating materials include, but are not limited to, metal, talc, other minerals, alumina films, amorphous silica, nanoparticle materials (e.g., materials containing carbon nanotubes or aluminum titanate), optical fiber material, and silica (glass) material.

The internal breaker may be any material capable of breaking the fluid loss control pill (i.e., reducing the viscosity of the fluid loss control pill to a value low enough that it flows naturally from the formation under the influence of the formation fluids and pressure). Examples of suitable internal breakers include inorganic salts, organic acids, or oxidizers. The inorganic salts may slowly convert into inorganic acids in the presence of water. The inorganic salts may include alkali metal salts, such as bisulfite salts, such as sodium bisulfite (NaHSO₃), bisulfate salts, metabisulfite salts, such as sodium metabisulfite (Na₂S₂O₅), metabisulfate salts, peroxides, persulfates, bromates, sodium bicarbonate (NaHCO₃), sodium hydro sulfide (NaHS), sodium bisulfate (NaHSO₄), monosodium phosphate (NaH₂PO₄), or disodium phosphate (Na₂HPO₄). Alternatively, the inorganic salts may include ammonium chloride (NH₄Cl) or ammonium oxalate ((NH₄)₂C₂O₄H₂O). The inorganic acids formed by the inorganic salts may include sulfamic acid (H₃NSO₃), sulfonic acid and its derivatives, such as toluenesulfonic acid (C₆H₄CH₃SO₃H), phosphonic acids and its derivatives (ROP(OH₂) where R is an organic radical such as C₆H₅, as in phenylphosphonic acid), aluminum chloride (AlCl₃), or other Lewis acids. Another example of a suitable inorganic acid is boric acid. The organic acids may include citric acid, oxalic acid, tartaric acid, lactic acid, or polylactic acid. The oxidizers may include peroxide, persulfate, bromate, perborate, or periodate.

Upon being introduced into a wellbore, the encapsulated particles of the fluid loss control pill may act as bridging particles blocking fluid loss from the wellbore into a formation. After a delay time period, the fluid loss control pill may begin to release the encapsulated internal breaker from within the polymer coating. The internal breaker may serve to break the fluid loss control pill. The delay time period may be in the range of a few hours to several days. In one embodiment, the polymer coating is formed of a crosslinked polymer and, upon its release, the internal breaker may lower the pH of the fluid loss control pill to an acidic pH suitable to uncrosslink the polymer coating and break the fluid loss control pill. The internal breaker may be released by any mechanism for releasing an encapsulated material known in the art. For example, the internal breaker may be allowed to diffuse through the polymer coating. Alternatively, the polymer coating may be formed of a self-degradable polymer such that the internal breaker may be released as the polymer coating degrades. The internal breaker released from the encapsulated particles may provide controlled breaking over a time period of a few hours to several days. The fluid loss control pill may have a pH ranging from 4 to 11. The internal breaker released from the encapsulated particles may provide complete breaking of the fluid loss control pill.

A live treatment may also be introduced into the wellbore at a desired point in time to assist the released internal breaker in breaking the fluid loss control pill. The live treatment may include an organic acid, such as acetic acid, or an inorganic acid, such as hydrochloric acid. Alternatively, the live treatment may be an oxidizer or enzyme.

The fluid loss control pill of this embodiment may be used in the same applications as existing prior art fluid loss control pills, such as drilling, fracturing, stimulation treatments, gravel-packing, and during completions.

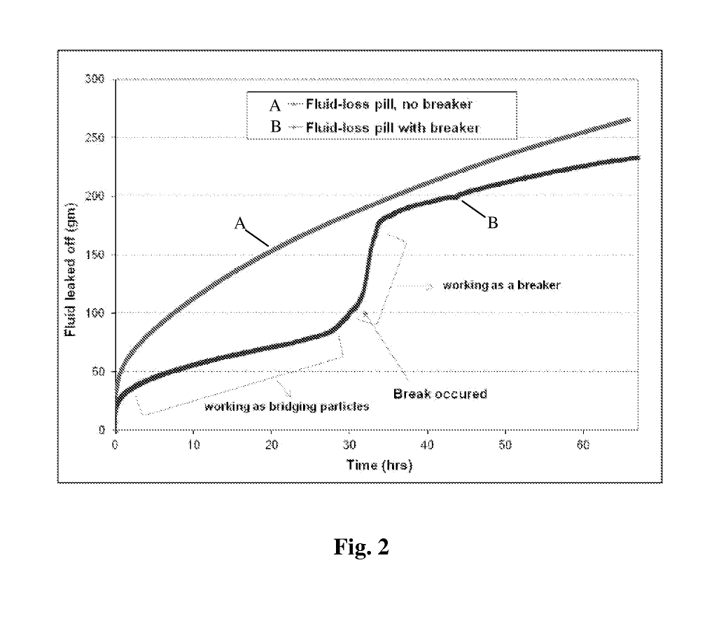

The fluid loss control pill with encapsulated particles has been shown to exhibit better fluid loss control than existing prior art fluid loss control pills. FIG. 2 shows the experimental fluid loss results of this fluid loss control pill. In this experiment, the polymer coating included PVDC and cross-linked HEC. The encapsulated internal breaker included sodium bisulfite (NaHSO₃). The base fluid was a 5% potassium chloride brine. The temperature of the fluid loss cell was approximately 200 degrees Fahrenheit. The pressure of the fluid loss cell was approximately 500 psi. The viscosity of the fluid loss control pill was about 250 cp at a shear rate of 10 s⁻¹. After breaking, the viscosity of the fluid loss control pill was about 35 cp at a shear rate of 10 s⁻¹.

In this experiment, the fluid loss control pill with encapsulated particles worked as bridging particles from the beginning of the experiment until about 30 hours. During this time the fluid loss control pill of this embodiment showed better fluid loss control results than the prior art fluid loss control pill having no encapsulated internal breaker as shown in FIG. 2. The fluid loss control pill of this embodiment then served as a breaker from about 30 hours to about 34 hours.

Although the present invention has been described in considerable detail with reference to certain preferred versions thereof, other versions are possible. Therefore, the spirit and scope of the appended claims should not be limited to the description of the preferred versions contained herein.

I claim:

1. A method of treating a subterranean formation comprising the steps of:
a) providing a fluid loss control pill comprising a plurality of encapsulated particles in a base fluid, wherein each encapsulated particle comprises a polymer coating encapsulating an internal breaker;
b) introducing the fluid loss control pill into a wellbore in a subterranean formation;
c) allowing the fluid loss control pill to prevent loss of a wellbore fluid from the wellbore into the subterranean formation; and
d) allowing the internal breaker within each encapsulated particle to be released from the polymer coating after a delay time period such that the fluid loss control pill is allowed to break.

2. The method of claim 1, wherein the wellbore fluid is aqueous.

3. The method of claim 2, wherein the polymer coating is insoluble in water at the temperature in the wellbore and the internal breaker is soluble in water.

4. The method of claim 1, wherein the polymer coating is porous, and wherein step (d) comprises allowing the internal breaker to be released from the polymer coating by diffusion through the polymer coating.

5. The method of claim 1, wherein the polymer coating is self-degradable, and wherein step (d) comprises allowing the internal breaker to be released from the polymer coating by degradation of the polymer coating.

6. The method of claim 1, wherein the polymer coating is formed of a polymer that is crushed under higher pressure, and wherein step (d) comprises allowing the internal breaker to be released from the polymer coating as the polymer coating is crushed under the pressure in the wellbore.

7. The method of claim 1, wherein the internal breaker comprises bisulfite ions, bisulfate ions, peroxides, persulfates, or bromates.

8. The method of claim 1, wherein the internal breaker comprises bisulfate salt, bisulfite salt, metabisulfite salt, or metabisulfate salt.

9. The method of claim 1, wherein the internal breaker comprises citric acid, oxalic acid, tartaric acid, lactic acid, or polylactic acid.

10. The method of claim 1, wherein the internal breaker comprises peroxide, persulfate, bromate, perborate, or periodate.

11. The method of claim 1, wherein the polymer coating comprises a crosslinked polymer, and wherein in step (d) the fluid loss control pill is allowed to break by allowing the internal breaker to lower the pH of the fluid enough to uncrosslink the crosslinked polymer of the polymer coating.

12. The method of claim 1, wherein in step (b) the fluid loss control pill is introduced into the wellbore in the form of a solution, a slurry, or a solid.

13. The method of claim 1, wherein the base fluid comprises sodium chloride brine, potassium chloride brine, calcium chloride brine, calcium bromide brine, zinc chloride brine, zinc bromide brine, or sodium formate brine.

14. The method of claim 1, further comprising the steps of:
e) introducing a live treatment into the wellbore to assist in breaking the fluid loss control pill.

15. The method of claim 14, wherein the live treatment comprises acetic acid.

16. The method of claim 14, wherein the live treatment comprises hydrochloric acid.

17. The method of claim 14, wherein the live treatment comprises an oxidizer or an enzyme.

18. A method of treating a subterranean formation comprising the steps of:
a) providing a fluid loss control pill comprising a plurality of encapsulated particles in a base fluid, wherein each encapsulated particle comprises a polymer coating encapsulating an internal breaker, wherein the polymer coating is insoluble in water and the internal breaker is soluble in water, and wherein the base fluid comprises a brine;
b) introducing the fluid loss control pill into a wellbore in a subterranean formation;
c) allowing the fluid loss control pill to prevent loss of an aqueous wellbore fluid from the wellbore into the subterranean formation; and
d) allowing the internal breaker within each encapsulated particle to be released from the polymer coating over a release time period after a delay time period such that the fluid loss control pill is allowed to break.

19. The method of claim 18, wherein in step (b) the fluid loss control pill is introduced into the wellbore in the form of a solution, a slurry, or a solid.

20. The method of claim 18, wherein the internal breaker comprises an inorganic salt, an organic acid, or an oxidizer.

21. The method of claim 18, wherein the polymer coating is porous, and wherein step (d) comprises allowing the internal breaker to be released from the polymer coating by diffusion through the polymer coating.

22. The method of claim 18, wherein the polymer coating is self-degradable, and wherein step (d) comprises allowing the internal breaker to be released from the polymer coating by degradation of the polymer coating.

23. The method of claim 18, wherein the polymer coating is formed of a polymer that is crushed under higher pressure, and wherein step (d) comprises allowing the internal breaker to be released from the polymer coating as the polymer coating is crushed under the pressure in the wellbore.

24. The method of claim 18, wherein the polymer coating comprises a crosslinked polymer, and wherein in step (d) the fluid loss control pill is allowed to break by allowing the internal breaker to sufficiently lower the pH of the fluid loss control pill such that the crosslinked polymer of the polymer coating is uncrosslinked.

25. The method of claim 18, further comprising the steps of:
e) introducing a live treatment into the wellbore to assist in breaking the fluid loss control pill, wherein the live treatment comprises an organic acid, an inorganic acid, an oxidizer, or an enzyme.
